(19) United States
(12) Patent Application Publication
(10) Pub. No.: US 2008/0027931 A1
(43) Pub. Date: Jan. 31, 2008

(54) SYSTEMS AND METHODS FOR PUBLISHING, SEARCHING, RETRIEVING AND BINDING METADATA FOR A DIGITAL OBJECT

(75) Inventors: JIAN LU, Cupertino, CA (US); Yangbin Wang, Milpitas, CA (US)

Correspondence Address: PILLSBURY WINTHROP SHAW PITTMAN LLP, P.O. BOX 10500, MCLEAN, VA, 22102, US

(73) Assignee: VOBILE, INC., Santa Clara, CA (US)

(21) Appl. No.: 11/679,822

(22) Filed: Feb. 27, 2007

Related U.S. Application Data
(60) Provisional application No. 60/777,753, filed on Feb. 27, 2006.

(51) Int. Cl. G06F 17/30

(52) U.S. Cl. 707/6

(57) ABSTRACT

Systems and methods are described for publishing, searching, retrieving and binding metadata with a digital object. A content-based ID can be employed to uniquely identify a digital object and associate metadata with the digital object. Content-based IDs can be a unique code, or a string of bits or some other unique identifier that can be consistently recalculated from the digital object and can serve as a permanent identifier for the digital object. Systems and methods are described for publishing metadata by wrapping metadata with a content-based ID for a digital object. According to certain aspects of the invention, the metadata can be published in a syndication feed including an RSS feed. An extension to syndication feeds is described that includes a tag for publishing metadata about a digital media object with a more generalized content-based ID.

### CROSS-REFERENCE TO RELATED APPLICATIONS

The present application claims priority from U.S. Provisional Patent Application Ser. No. 60/777,753, filed Feb. 27, 2006, entitled “Method and System For Publishing, Searching, Retrieving, and Binding Metadata for a Digital Object” and which is incorporated herein by reference and for all purposes. The present invention is also related to U.S. Non-Provisional patent application Ser. No.______, filed Feb. 27, 2007, entitled “Systems and Methods of Fingerprinting and Identifying Digital Versatile Disc” and which is incorporated herein by reference in its entirety.

### BACKGROUND OF THE INVENTION

1. Field of the Invention

The present invention relates generally to techniques for handling metadata for a digital object and more particularly to methods and systems for publishing, searching, retrieving, and binding metadata for a digital video object using content-based IDs that are computed from the digital video object.

2. Description of Related Art

The proliferation of computing and Internet technologies is producing a large number of digital objects at a rapid pace including digital files and bitstreams that can be stored on a computer and/or broadcast or streamed to a television or computer.

The term “metadata”, or “data about data”, is data that describes another set of data. Digital objects, particularly digital media objects such as picture and video can often be associated with metadata. Generally speaking, metadata for a digital object can include data that describes the content in a digital object, and data that describes the attributes of the digital object. For digital media objects, metadata is often essential in providing a richly informative and user-friendly media software and service.

Metadata may be embedded in or provided separately from a digital object. In both cases the binding of the metadata with a digital object is generally artificial and can be easily broken because metadata is not an integral part of the media data. For example, an MP3 music file may contain an embedded ID3 metadata tag to describe title, artist, and copyright holder of encoded music, but the tag can be removed from the MP3 file without affecting the integrity of the MP3 and playback of MP3 music is unaffected by presence or absence of the tag.

More generally, metadata is often detached from the digital object it describes. For example, many reviews written by different people may be available for a movie. These reviews may be published in different Web sites. While a human may find these reviews for a movie of interest using a keyword-based Web search engine, it is much harder for a computer to automatically and accurately find such information. Similarly, after embedded metadata such as an ID3 tag is stripped from its associated digital object or media data, it requires human intelligence to determine pairing and binding of media data with its associated metadata. Thus, systems and methods for facilitating publishing, searching, retrieving and binding of metadata with a digital object in an automatic way are needed.

### BRIEF SUMMARY OF THE INVENTION

Embodiments of the invention provide systems and methods for publishing, searching, retrieving and binding metadata with a digital object. Certain embodiments of the invention employ a content-based ID to uniquely identify a digital object and associate metadata with the digital object. A content-based ID can be a unique code, a string of bits or some other unique identifier that can be computed from the digital object itself The content-based ID can be consistently recalculated from the digital object and therefore can serve as a permanent identifier for the digital object. By referencing to content IDs throughout the system, aspects of the present invention facilitate publishing, searching, retrieving and binding of metadata to its associated digital object.

In certain embodiments, publishing metadata comprises wrapping metadata with a content-based ID for a digital object in a Really Simple Syndication feed. Certain embodiments of the invention employ an extension to syndication feeds that include a tag for publishing metadata about a digital media object with a more generalized content-based ID.

In certain embodiments, searching metadata associated with a particular digital object can be performed on a local hard disk drive of a computer or over a network such as a local-area network (LAN) or the Internet. A search may be initiated and executed automatically on a local computing device such as a computer or a digital video recorder, or among several computing devices over a network. Searches may also be initiated and executed on an Internet search engine. In certain embodiments, a metadata search based on a selected content-based ID can discover all metadata that is associated with the selected content-based ID. When metadata is found to be associated with a content-based ID that exactly matches the selected content-based ID, the metadata can be retrieved and bound to the associated digital object based on the content-based ID of the digital object. In certain embodiments, a table used to record binding relationship may be implemented such that all video objects and their associated metadata or links to metadata are stored in a single table where different objects are identified by their content-based object IDs. In certain embodiments, the binding relationship may be stored in a relational database.

### BRIEF DESCRIPTION OF THE DRAWINGS

FIG. 1 is a flowchart illustrating one example of a process according to certain aspects of the invention.

FIG. 2 is a flowchart illustrating one example of a Web search according to certain aspects of the invention.

FIG. 3 is an example of a Web page returned by a search engine in response to a user query containing “Air Force One.”

FIG. 4 is a block drawing illustrating a system according to certain aspects of the invention.

### DETAILED DESCRIPTION OF THE INVENTION

Embodiments of the present invention will now be described in detail with reference to the drawings, which are provided as illustrative examples so as to enable those skilled in the art to practice the invention. Notably, the figures and examples below are not meant to limit the scope of the present invention to a single embodiment, but other embodiments are possible by way of interchange of some or all of the described or illustrated elements. Wherever convenient, the same reference numbers will be used throughout the drawings to refer to same or like parts. Where certain elements of these embodiments can be partially or fully implemented using known components, only those portions of such known components that are necessary for an understanding of the present invention will be described, and detailed descriptions of other portions of such known components will be omitted so as not to obscure the invention. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the components referred to herein by way of illustration.

Embodiments of the invention provide systems and methods for facilitating automatic publishing, searching, retrieving and binding of metadata with a digital object. In the following descriptions, the term “digital object” may be interchangeably used to refer to a digital file or a bitstream. For example, a computer file stored on a hard disk drive and a broadcast or streamed video bitstream may both be described as digital objects.

Certain embodiments of the invention employ a content-based ID to uniquely identify a digital object and associate metadata with the digital object. A content-based ID, also known as “digital fingerprint” or “fingerprint” can be a unique code, a string of bits or some other unique identifier that can be computed from the digital object itself. A content-based ID for a digital object such as a computer file can be its binary hash. In some embodiments, the MD5 hash specified by RFC 1321 may be employed. Certain embodiments of the invention can use the digital fingerprints described in U.S. Non-Provisional patent application Ser. No. ______, filed Feb. 27, 2007, entitled “Systems and Methods of Fingerprinting and Identifying Digital Versatile Disc”.

The use of content-based IDs for relating a digital object to its associated metadata can yield significant advantages in certain embodiments of the invention, especially when metadata is detached from the digital object. Some advantages arise because a content-based ID can always be computed and re-computed from a digital object and therefore can serve as a permanent identifier for the digital object. Because the content-based ID can be consistently recalculated from the digital object, it can serve as a permanent identifier for the digital object. By referencing to content IDs throughout the system, the present invention can facilitate publishing, searching, retrieving and binding of metadata to its associated digital object.

Publishing Metadata

In certain embodiments, publishing metadata comprises wrapping metadata with a content-based ID for a digital object in a Really Simple Syndication (“RSS”) feed. RSS is an example of content syndication on the Web using an XML file format. Although, RSS started in news headline syndication, current RSS feeds can carry a wide array of content types, including news headlines, forums and blogs, software announcements, as well as metadata. RSS has become particularly popular in blogging and podcasting services in recent years and an extension known as Media RSS or MRSS has been made for syndicating media content.

The MRSS specification defines a <media:hash> tag that may be viewed as a content-based ID. However, for digital media object a binary hash is not a good identifier because of its sensitivity to even a single bit change in the digital object. Certain embodiments of the invention employ an extension to MRSS that includes a new <media:ID> tag in order to use MRSS to publish metadata about a digital media object with a more generalized content-based ID.

In one example of an RSS feed having this new ID tag included in a metadata publication, a movie review is contained in metadata that is tagged for a digital object with ID=fc1198178c3594bfdda3ca2996eb65cb. XML code may then take the form:

<rss version=“2.0” xmlns:media=“http://search.yahoo.com/mrss”
xmlns:vobileMRSSext=“http://mrss.vobileinc.com/mrssext ”>
<channel>
<title>My Movie Review</title>
<link>http://www.foo.com</link>
<description>I review movies.</description>

<item>

<title>Air Force One (1997): A great action movie?</title>
<link>http://www.foo.com/item1.htm</link>
<media:content url=http://www.foo.com/trailer.mov
fileSize=“12216320” type=“video/mp4” expression=“sample”/>
<media:rating>R</media:rating>
<media:ID algo=“vobile”>
fc1198178c3594bfdda3ca2996eb65cb</media:ID>

</item>

</channel>
</rss>

In this example, the <media:ID> tag is used simply for announcing the digital object ID with which the piece of metadata is associated. The qualifier ‘algo=“vobile”’ specifies the algorithm by which the object ID is generated. This is necessary because that like hashing, a content-based object ID may be generated by different methods; the ‘algo’ qualifier resolves the ambiguity.

The inclusion of a content-based object ID in metadata publication makes it possible for computers or other computing devices in hardware or software to automatically find and retrieve the associated metadata, as is described in the next section, “Searching, Retrieving and Binding Metadata.”

Searching, Retrieving, and Binding Metadata

In certain embodiments, searching metadata associated with a particular digital object can be performed on a local hard disk drive of a computer or over a network such as a local-area network (LAN) or the Internet. A search may be initiated and executed automatically on a local computing device such as a computer or a digital video recorder, or among several computing devices over a network. Searches may also be initiated and executed on an Internet search engine. In certain embodiments, user actions may initiate a search where user actions can include activating an application, causing an application to be executed, opening or attempting to open a digital object, inserting a DVD or other storage and copying a digital object.

In certain embodiments, a metadata search based on a selected content-based ID attempts to discover all metadata that is associated with the selected content-based ID. When metadata is found to be associated with a content-based ID that exactly matches the selected content-based ID, the metadata can be retrieved and bound to the associated digital object based on the content-based ID of the digital object. In contrast, conventional search engines, such as Google, return numerous pages of search hits having varying degrees of relevance and users must sift through the pages to find relevant information.

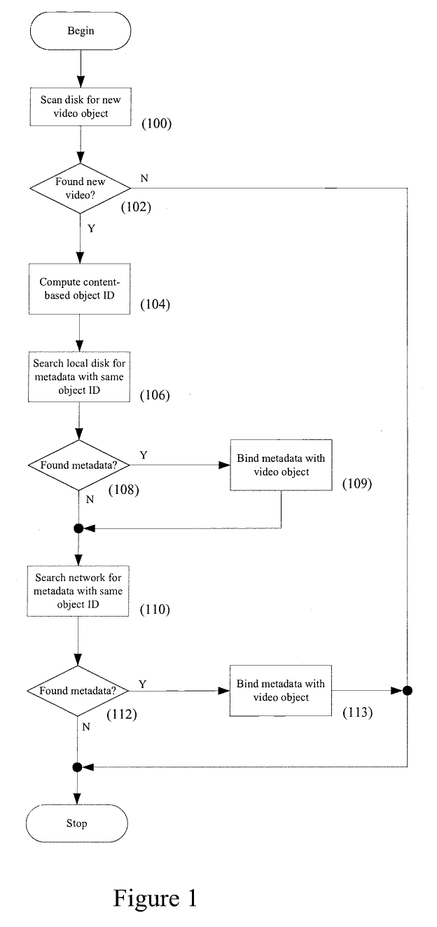

FIG. 1 provides a flowchart for one example of a metadata search according to certain aspects of the invention. At step 100, a metadata search can be initiated and executed on a local computing device such as a personal computer or other device. In one example, video jukebox software that subscribes to metadata feeds from the Internet may be configured to scan a local hard disk drive to find and import a video object file. If a new video object is discovered at step 102, the process continues. At step 104, a content-based object ID can be computed for the newly-discovered video object. Then at step 106, the computed object ID may be used to search the local disk for items, files and objects that are associated with the object ID or include the object ID. If metadata is found at step 108, then the metadata can be bound with the video object at step 109.

At step 110, a network search for metadata associated with the object ID can be conducted. The search may include local networks, the Internet and other networks. If metadata is found at step 112, then the metadata can be bound with the video object at step 113.

Metadata can be bound to a video object (and other digital objects) by linking the metadata to the video digital object. Binding need not include attaching the metadata to the digital object in a file or bitstream. Binding can be achieved by referencing both the digital object and the associated metadata to a content-based object ID. In the example illustrated in FIG. 1, metadata can be bound to a digital object by creating a table named or otherwise identified by the object ID created at step 104.

TABLE 1
fc1198178c3594bfdda3ca2996eb65cb.tbl

| Item | Location |
|---|---|
| 1 | C:\My Documents\metadata\fc1198178c3594bfdda3ca2996eb65cb.xml |
| 2 | http://meta.foo.com/fc1198178c3594bfdda3ca2996eb65cb/review.htm |

For example, if the obtained object ID is “fc1198178c3594bfdda3ca2996eb65cb,” then the table may be given a name such as “fc1198178c3594bfdda3ca2996eb65cb.tbl.” Thereafter, any metadata that is found, or a URL or other pointer that links or identifies found metadata, can be added to the table. Table 1 illustrates a table that records bindings between metadata and a video object. In the example illustrated in Table 1, two pieces of metadata are found and bound. The first item identifies a piece of metadata stored on a local hard drive and records its file path. The second item identifies a piece of metadata that resides on a remote server and records its URL.

In certain embodiments, a table used to record binding relationship may be implemented such that all video objects and their associated metadata or links to metadata are stored in a single table where different objects are identified by their content-based object IDs. In certain embodiments, the binding relationship may be stored in a relational database. Other methods of recording and maintaining links based on content-based object ID to bind digital objects and associated metadata are contemplated. The examples provided above are presented for illustrative purposes only.

In certain embodiments, the latterly described method can be completely or partially performed automatically. In one example, the method may be executed upon user request. In another example, the method may be executed based on a predetennined schedule, and/or upon initiation of the video jukebox or other video processing software. In at least some embodiments, the process may be automatically initiated when a video object file is stored on a local disk drive.

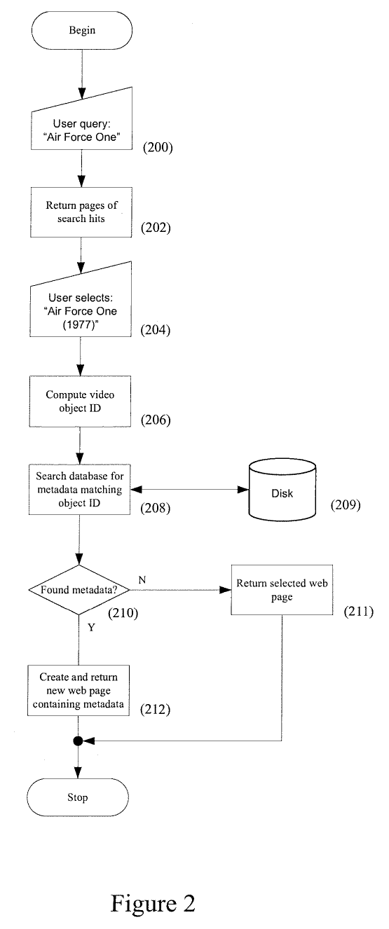

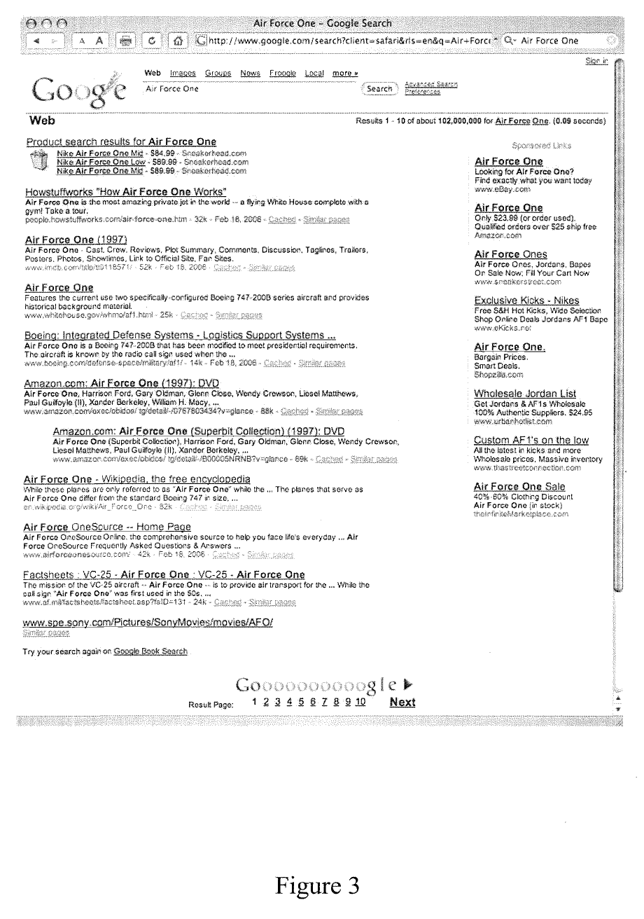

FIG. 2 provides a flowchart for another example of a metadata search according to certain aspects of the invention. In this example, the metadata search is initiated and executed on a search engine such as Google, typically in response to a user query. At step 200, a user enters a query to the search engine. In the example, the query is the name of a movie title: “Air Force One.” At step 202, the search engine returns one or more pages of search results (hits). An example of a first page of search results returned by a search engine is shown in FIG. 3. The user can then select one of the returned search hits at step 204. In the example, the user may select a result identified as “Air Force One (1997)” indicating a desire to search for the movie named “Air Force One” which has a content-based object ID known to the search engine or that can be computed or otherwise obtained by the search engine at step 206. At step 208, the search engine may search its database 209 for all matches to the object ID. If no matches are found at step 210, then the search engine can merely return the selected web page (“Air Force One (1997)”). However, when metadata is determined to have been found at step 210, then the metadata can be provided in a new web page at step 212 for presentation to the requesting user. The new page can list information specific to the identified movie, wherein the information may include metadata and known download links to the identified movie.

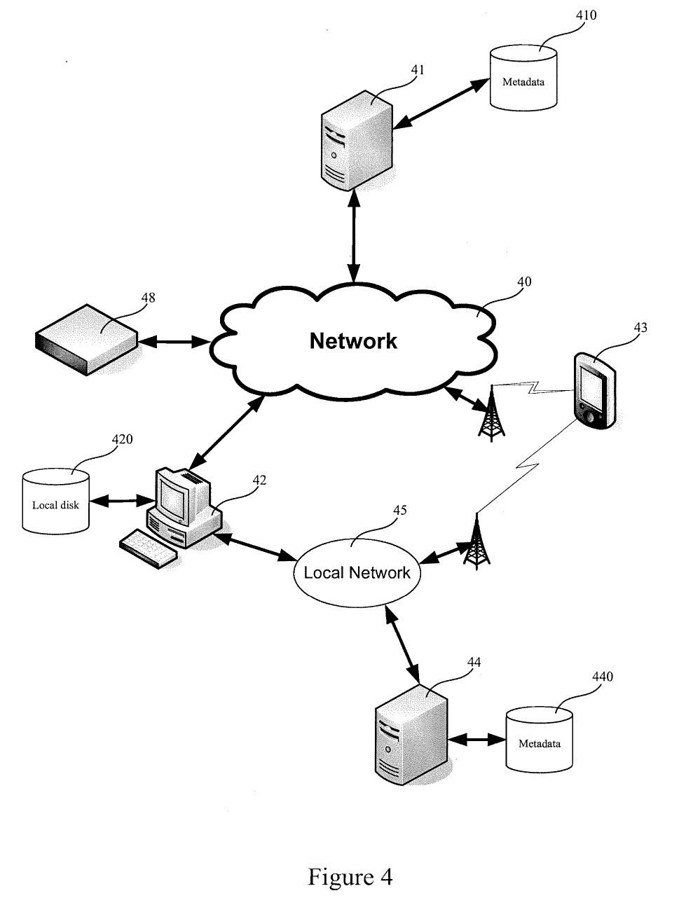

FIG. 4 illustrates a system according to aspects of the present invention. User devices 42, 43 and 48 can be configured to communicate with one or more networks 40 and 45. In one example, a personal computer 42 may be connected to the Internet 40 or a wide area network and/or can be connected to one or more local networks 45. User device 43 can be adapted to communicate wirelessly with one or more networks 40 and 45 and can include mobile computing devices such as laptops, PDAs, media players, cellular telephones and other such equipment. In certain embodiments, a cable/satellite receiver, DVR, DVD or other media player 48 can be configured to connect with one or more networks 40 and 45. Servers 41 and 44 can be provided to maintain databases 410 and 440 or other repositories for maintaining metadata. In certain embodiments, server2 41 and 44 can maintain tables or databases for binding or linking metadata with corresponding digital objects.

User devices 42, 43 and 48 can include browser that permit a user to browse one or more networks 40 and 45 to locate digital objects that are of interest or specifically desired. User devices 42, 43 and 48 can then calculate, or cause to be calculated, a content-specific ID that can be used to identify metadata related to the located digital objects. Content-specific IDs may be calculated using a server at the request of user devices 42, 43 and 48 or may be provided with the digital object, particularly where the provider of the digital object is a trusted source of such objects.

Additional Descriptions of Certain Aspects of the Invention

Certain embodiments of the invention comprise method of binding metadata to a digital object comprising calculating a content-based ID from data extracted from the digital object, the content-based ID uniquely identifying the digital object, identifying metadata having the calculated content-based ID as a tag, and binding the identified metadata with the digital object. In certain of these embodiments, the steps of calculating, identifying and binding are performed automatically. In certain of these embodiments, the digital object is obtained by searching the Internet. In certain of these embodiments, the digital object is obtained responsive to a user action. In certain of these embodiments, the digital object is obtained by searching local storage. In certain of these embodiments, the metadata is identified in metadata published in a content syndication feed. In certain of these embodiments, the content syndication feed is an RSS feed. In certain of these embodiments, the metadata is provided by a web page. In certain of these embodiments, the metadata is identified in a database configured to maintain metadata referenced by content-based ID. In certain of these embodiments, the digital object is obtained as a streamed video program. In certain of these embodiments, the digital object is obtained from one or more broadcast sources, the broadcast sources including cable television providers, satellite television providers and UHF/VHF television stations. In certain of these embodiments, the extracted data comprises a video object and wherein repeating the calculating step yields a recomputed content-based ID identical to the first-calculated content-based ID. In certain of these embodiments, the binding includes recording a location of identified metadata in a table. In certain of these embodiments, the table is configured to record locations of metadata bound to a plurality of digital objects. Certain of these embodiments further comprise maintaining a plurality of tables, each table associated with a different digital object and configured to record locations of metadata having as a tag a content-based ID corresponding to the different digital object. In certain of these embodiments, the identifying metadata includes using the calculated content-based ID as a search term for searching the Internet. In certain of these embodiments, the identifying metadata includes using the calculated content-based ID as a search term for searching local storage. Certain of these embodiments are executed using a custom configured media player. Certain of these embodiments are executed in response to instructions and data provided on a storage device.

Certain embodiments comprise a media player configured to calculate a content-based ID for a digital object from data extracted from the digital object, the content-based ID uniquely identifying the digital object, identify metadata having the calculated content-based ID as a tag, and bind the identified metadata with the digital object. In certain of these embodiments, the selected digital object is provided by a Web page obtained by searching the Internet. In certain of these embodiments, the selected digital object is obtained from local storage. In certain of these embodiments, the metadata is identified in metadata published as an RSS feed. In certain of these embodiments, the metadata is provided by a web page. In certain of these embodiments, the identified metadata is maintained in storage configured to reference metadata by content-based ID. In certain of these embodiments, the selected digital object comprises a video object. In certain of these embodiments, the digital object is derived from streamed video. In certain of these embodiments, the digital object is derived from a broadcast television source. In certain of these embodiments, the media player is a DVD player. In certain of these embodiments, the media player is provided as an application in a computing device. Certain of these embodiments also comprise a browser, wherein the identified metadata includes metadata obtained by the browser by searching the Internet using the calculated content-based ID as a search term.

Certain embodiments comprise a computer readable medium encoded with data and instructions for binding metadata to a digital object, the data and instructions causing an apparatus executing the instructions to calculate a content-based ID from data extracted from the digital object, the content-based ID uniquely identifying the digital object, identify metadata having the calculated content-based ID as a tag, and bind the identified metadata with the digital object. In certain of these embodiments, the digital object is provided by a Web page obtained by searching the Internet. In certain of these embodiments, the digital object is obtained by searching local storage. In certain of these embodiments, the metadata is identified in metadata published as an RSS feed. In certain of these embodiments, the identified metadata is obtained by using the content-based ID to query a database. In certain of these embodiments, the digital object is obtained from a video stream. In certain of these embodiments, the digital object is a video object obtained from one or more broadcast sources, the broadcast sources including cable television providers, satellite television providers. In certain of these embodiments, the medium is further encoded with data and instructions for causing the apparatus to record a location of identified metadata in a table. In certain of these embodiments, the table is configured to record locations of metadata bound to a plurality of digital objects. In certain of these embodiments, the medium is further encoded with data and instructions causing an apparatus to maintain a plurality of tables, each table associated with a different digital object and configured to record locations of metadata having as a tag a content-based ID corresponding to the different digital object. In certain of these embodiments, the medium is further encoded with data and instructions causing an apparatus to record a location of identified metadata in a table. In certain of these embodiments, the medium is further encoded with data and instructions causing an apparatus to automatically execute the calculate, identify and bind instructions. In certain of these embodiments, the calculate, identify and bind instructions are automatically executed according to a predetermined schedule. In certain of these embodiments, the calculate, identify and bind instructions are automatically executed in response to a user action.

Certain embodiments comprise a method of searching for metadata associated with a digital object comprising calculating a content-based ID from data extracted from the digital object, and searching for metadata using the content-based ID as a search term, wherein the content-based ID uniquely identifies certain characteristics of the digital object and the searching returns metadata that includes the content-based ID. In certain of these embodiments, the searching includes searching the Internet. In certain of these embodiments, the searching includes searching local storage. In certain of these embodiments, the content-based ID is included in the returned metadata as a media:ID. In certain of these embodiments, the digital object is obtained as a streamed video program. In certain of these embodiments, the digital object is obtained from one or more broadcast sources, the broadcast sources including cable television providers, satellite television providers and UHF/VHF television stations. Certain of these embodiments are executed using a custom configured media player. Certain of these embodiments are executed in response to instructions and data provided on a storage device.

Certain embodiments comprise a method of publishing metadata comprising wrapping metadata with a content-based ID associated with a digital object, providing the wrapped metadata in a content syndication feed, wherein the content-based ID uniquely identifies certain characteristics of the digital object and the wrapped metadata includes information related to the digital object. In certain of these embodiments, the content syndication feed is an RSS feed. Certain of these embodiments further comprise calculating a content-based ID from data extracted from the digital object. In certain of these embodiments, the wrapping includes adding the content-based ID certain metadata as a media:ID. In certain of these embodiments, the extracted data includes digital video and the content-based ID uniquely identifying the digital video. In certain of these embodiments, the digital video includes a streamed video program. In certain of these embodiments, the digital video is obtained from one or more broadcast sources, the broadcast sources including cable television providers, satellite television providers and UHF/VHF television stations. Certain of these embodiments are executed using a custom configured media player. Certain of these embodiments are executed in response to instructions and data provided on a storage device.

Although the present invention has been described with reference to specific exemplary embodiments, it will be evident to one of ordinary skill in the art that various modifications and changes may be made to these embodiments without departing from the broader spirit and scope of the invention. Accordingly, the specification and drawings are to be regarded in an illustrative rather than a restrictive sense.

What is claimed is:

1. A method of binding metadata to a digital object comprising:
calculating a content-based ID from data extracted from the digital object, the content-based ID uniquely identifying the digital object;
identifying metadata having the calculated content-based ID as a tag; and
binding the identified metadata with the digital object.

2. The method of claim 1, wherein the steps of calculating, identifying and binding are performed automatically.

3. The method of claim 1, wherein the digital object is obtained by searching the Internet.

4. The method of claim 1, wherein the digital object is obtained responsive to a user action.

5. The method of claim 1, wherein the digital object is obtained by searching local storage.

6. The method of claim 1, wherein the metadata is identified in metadata published in a content syndication feed.

7. The method of claim 6, wherein the content syndication feed is an RSS feed.

8. The method of claim 1, wherein the metadata is provided by a web page.

9. The method of claim 1, wherein the metadata is identified in a database configured to maintain metadata referenced by content-based ID.

10. The method of claim 1, wherein the digital object is obtained as a streamed video program.

11. The method of claim 1, wherein the digital object is obtained from one or more broadcast sources, the broadcast sources including cable television providers, satellite television providers and UHF/VHF television stations.

12. The method of claim 1, wherein the extracted data comprises a video object and wherein repeating the calculating step yields a recomputed content-based ID identical to the first-calculated content-based ID.

13. The method of claim 1, wherein the binding includes recording a location of identified metadata in a table.

14. The method of claim 13, wherein the table is configured to record locations of metadata bound to a plurality of digital objects.

15. The method of claim 13, and further comprising maintaining a plurality of tables, each table associated with a different digital object and configured to record locations of metadata having as a tag a content-based ID corresponding to the different digital object.

16. The method of claim 1, wherein the identifying metadata includes using the calculated content-based ID as a search term for searching the Internet.

17. The method of claim 1, wherein the identifying metadata includes using the calculated content-based ID as a search term for searching local storage.

18. A system for binding metadata comprising a media player configured to:
calculate a content-based ID for a digital object from data extracted from the digital object, the content-based ID uniquely identifying the digital object;
identify metadata having the calculated content-based ID as a tag; and
bind the identified metadata with the digital object.

19. The system of claim 18, wherein the selected digital object is provided by searching the Internet.

20. The method of claim 18, wherein the selected digital object is obtained responsive to a user action.

21. The system of claim 18, wherein the selected digital object is obtained from local storage.

22. The system of claim 18, wherein the metadata is identified in metadata published as an RSS feed.

23. The system of claim 18, wherein the metadata is provided by a web page.

24. The system of claim 18, wherein the identified metadata is maintained in storage configured to reference metadata by content-based ID.

25. The system of claim 18, wherein the selected digital object comprises a video object.

26. The system of claim 18, wherein the digital object is derived from streamed video.

27. The system of claim 18, wherein the digital object is derived from a broadcast television source.

28. The system of claim 18, wherein the media player is a DVD player.

29. The system of claim 18, wherein the media player is provided as an application in a computing device.

30. The system of claim 18, and further comprising a browser, wherein the identified metadata includes metadata obtained by the browser by searching the Internet using the calculated content-based ID as a search term.

31. A computer readable medium encoded with data and instructions for binding metadata to a digital object, the data and instructions causing an apparatus executing the instructions to:
calculate a content-based ID from data extracted from the digital object, the content-based ID uniquely identifying the digital object;
identify metadata having the calculated content-based ID as a tag; and
bind the identified metadata with the digital object.

32. The computer readable medium of claim 31, wherein the digital object is obtained by searching the Internet.

33. The method of claim 31, wherein the digital object is obtained responsive to a user action.

34. The computer readable medium of claim 31, wherein the digital object is obtained by searching local storage.

35. The computer readable medium of claim 31, wherein the metadata is identified in metadata published as an RSS feed.

36. The computer readable medium of claim 31, wherein the identified metadata is obtained by using the content-based ID to query a database.

37. The computer readable medium of claim 31, wherein the digital object is obtained from a video stream.

38. The method of claim 31, wherein the digital object is a video object obtained from one or more broadcast sources, the broadcast sources including cable television providers, satellite television providers.

39. The computer readable medium of claim 31 further encoded with data and instructions, the data and instructions further causing an apparatus executing the instructions to record a location of identified metadata in a table.

40. The computer readable medium of claim 39, wherein the table is configured to record locations of metadata bound to a plurality of digital objects.

41. The computer readable medium of claim 39, further encoded with data and instructions, the data and instructions further causing an apparatus executing the instructions to maintain a plurality of tables, each table associated with a different digital object and configured to record locations of metadata having as a tag a content-based ID corresponding to the different digital object.

42. The computer readable medium of claim 31, further encoded with data and instructions, the data and instructions further causing an apparatus executing the instructions to record a location of identified metadata in a table.

43. The computer readable medium of claim 31, further encoded with data and instructions, the data and instructions further causing an apparatus executing the instructions to automatically execute the calculate, identify and bind instructions.

44. The computer readable medium of claim 43, wherein the calculate, identify and bind instructions are automatically executed according to a predetermined schedule.

45. The computer readable medium of claim 43, wherein the calculate, identify and bind instructions are automatically executed in response to a user action.

46. A method of searching for metadata associated with a digital object comprising:
calculating a content-based ID from data extracted from the digital object; and
searching for metadata using the content-based ID as a search term, wherein
the content-based ID uniquely identifies certain characteristics of the digital object and the searching returns metadata that includes the content-based ID.

47. The method of claim 46, wherein the searching includes searching the Internet.

48. The method of claim 46, wherein the searching includes searching local storage.

49. The method of claim 46, wherein the content-based ID is included in the returned metadata as a media:ID.

50. The method of claim 46, wherein the digital object is obtained as a streamed video program.

51. The method of claim 46, wherein the digital object is obtained from one or more broadcast sources, the broadcast sources including cable television providers, satellite television providers and UHF/VHF television stations.

52. A method of publishing metadata comprising:
wrapping metadata with a content-based ID associated with a digital object;
providing the wrapped metadata in a content syndication feed, wherein
the content-based ID uniquely identifies certain characteristics of the digital object and the wrapped metadata includes information related to the digital object.

53. The method of claim 52, wherein the content syndication feed is an RSS feed.

54. The method of claim 52, and further comprising calculating a content-based ID from data extracted from the digital object.

55. The method of claim 54, wherein the wrapping includes adding the content-based ID certain metadata as a media:ID.

56. The method of claim 54, wherein the extracted data includes digital video and the content-based ID uniquely identifying the digital video.

57. The method of claim 54, wherein the digital video includes a streamed video program.

58. The method of claim 54, wherein the digital video is obtained from one or more broadcast sources, the broadcast sources including cable television providers, satellite television providers and UHF/VHF television stations.
